(19) United States
(12) Patent Application Publication
(10) Pub. No.: US 2011/0015861 A1
(43) Pub. Date: Jan. 20, 2011

(54) SYSTEM FOR COLLISION DETECTION BETWEEN OBJECTS

(76) Inventor: Vitaly Burkatovsky, Rishon Le Zion (IL)

Correspondence Address: Raymond L. Owens;Patent Legal Staff, Eastman Kodak Company, 343 State Street, Rochester, NY, 14650-2201, US

(21) Appl. No.: 12/502,270

(22) Filed: Jul. 14, 2009

(51) Int. Cl. G06F 17/00

(52) U.S. Cl. 701/301; 701/300

(57) ABSTRACT

A collision detection system (100) configured to detect collision between two objects, where first protected object (104) moves in the direction of a second protected object (108). A collision detection element (156, 112, 120, 136, 124) is attached to the first object, the collision element includes: an air flow source (156) configured to apply an air stream (116) in the direction of the second object, a pressure sensitive element (120) configured to sense the generated air pressure in the area (160) between the first object and the second object, a pressure data analysis module (140) attached to the pressure sensitive element. The pressure data analysis module configured to analyze the pressure levels generated, and an alert element (164, 144) configured to alert on an abnormal distance range between the first object and the second object.

### FIELD OF THE INVENTION

The present invention relates in general to collision detection between objects wherein at least one of the objects moves relative to the other object, and in particular to maintaining a relative distance between a moving imaging head and an imaging drum.

### BACKGROUND OF THE INVENTION

Electro-mechanical machinery is comprised of plurality of elements, often some of the elements may be configured to move within the machine. An example for such machinery is a computer-to-plate (CTP) imaging device. The imaging device includes a rotating drum adapted to carry a printing plate to be imaged by an imaging head, which is part of the CTP imaging device. The imaging head includes a laser source, configured to emit radiation on the printing plate. In addition, the imaging head will include an optical focus system, capable of focusing on regions of the plate surface and subsurface. When engraving a printing plate, the imaging head is required to move towards the rotating drum to enable the focus system to focus deeper into the printing plate. The movement of the imaging head towards the rotating drum must be controlled in order to avoid hazardous situations in the CTP imaging device. The invention described hereunder suggests an apparatus and methods to prevent collisions between the elements inside such devices.

### SUMMARY OF THE INVENTION

Briefly, according to one aspect of the present invention, a collision detection system is provided for objects moving relative to each other. In one embodiment, a collision detection unit is attached to the first object and includes an air flow source element for applying an air stream to the first and second object, a pressure sensitive unit for sensing air pressure between the first object and the second object, a pressure data analysis module for analyzing air pressure levels, and an alert unit configured to alert when an abnormal distance is detected between the first object and the second object.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein:

FIG. 1 is schematic illustration of a collision detection system;

FIG. 2 is a schematic illustration of pressure sensor behavior as a function of the distance between two objects;

FIG. 3 is a schematic illustration of an imaging device adapted to use a collision detection system;

FIG. 4 is schematic illustration of a collision detection system with a detached pressure sensor; and

FIG. 5 is schematic illustration of a collision detection system adapted to keep the objects within a range, wherein both minimum and maximum distances between the objects are guarded.

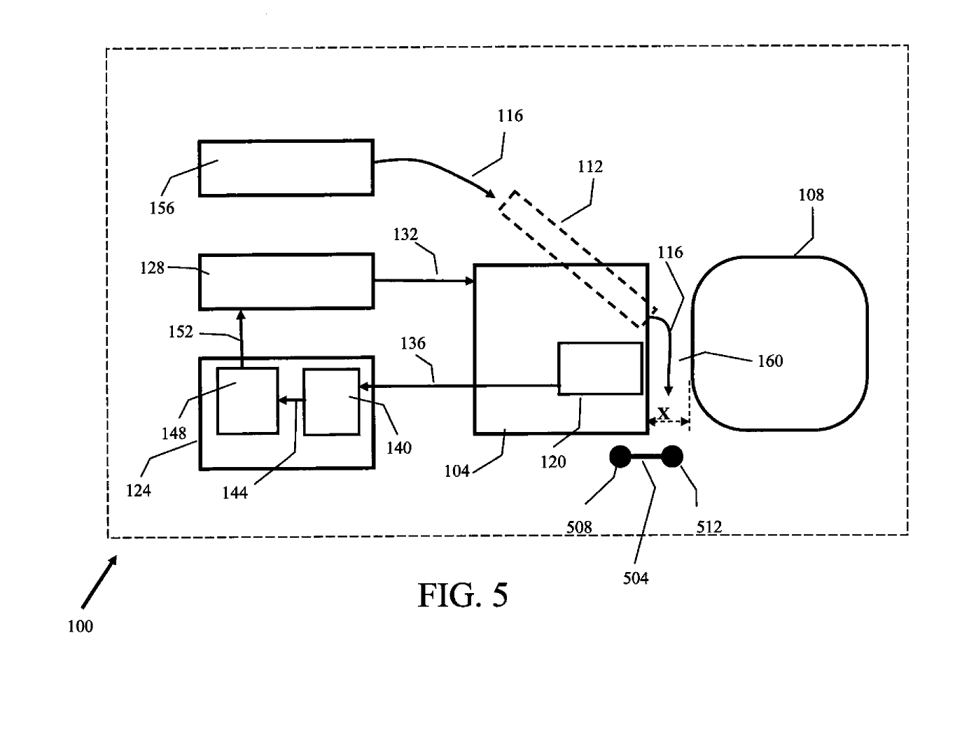

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

The present invention describes a collision detector method and apparatus integrated in an auxiliary device. The device is comprised of at least two objects which move relative to each other. The collision detector is adapted to sense a possible collision between the objects and produce an alert signal. The invention helps avoid collisions between moving objects.

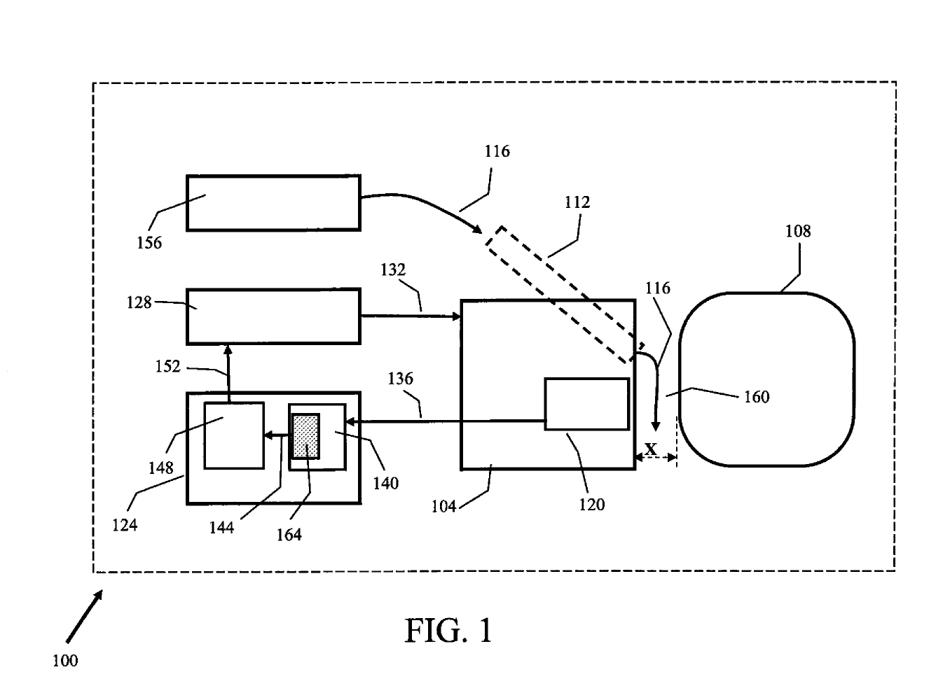

FIG. 1 shows an illustration of a collision detector 100 operable within a device. First protected object 104 is arranged to move in the direction of a second protected object 108. First protected object 104 movements is controlled by motor 128 through motor transmission 132. First protected object 104 is equipped with an air pressure sensor 120, such as a microphone, and an air flow channel 112.

In operation, air flow source 156 applies air flow 116. Air flow 116 propagates via air flow channel 112 to the possible collision area 160. While objects are far from each other, exhausted air has no obstacles on its way, and therefore the pressure in the possible collision area 160 is practically equal to atmosphere pressure. When objects approaching each other, the distance X between them becomes smaller, thus forcing the air to flow through the gap between the objects. The thickness of the gap X determines the resistance level to the air flow Rg. In this case pressure P in the possible collision area may be defined as follows: P=F×Rg (1) where F represents the air flow value. The resistance to air flow is inversely proportional to the distance between the objects and it can be represented as Rg=k/X (2), wherein k is a constant dependent on the gap geometry.

After substitution of equation (2) into (1) yields the following equation (3):

P=F×k/X (3)

Equation (3) shows that pressure in possible collision area 160 will grow as much as the distance between the objects becomes smaller.

Pressure sensor 120 senses the levels of the air pressure and sends a pressure signal 136 to controller 124, which detects the pressure level sensed in the possible collision area 160. Controller 124 comprises a signal analyzer 140 and motor control logic 148, the signal analyzer 140 also includes an alert element 164.

Pressure signal 136 is analyzed by signal analyzer 140. If signal analyzer 140 detects increasing pressure, which represents a possible collision between the first and second protected objects 104 and 108, an collision alert signal 144 is sent to motor control logic 148. The motor control logic 148 implementation may be based, for example, on a controller described in U.S. Pat. No. 7,505,847. Motor control logic 148 produces a motor control signal 152 to motor 128, which causes first protected object 104 to stop or move away from second protected object 108, thus preventing a collision between the objects.

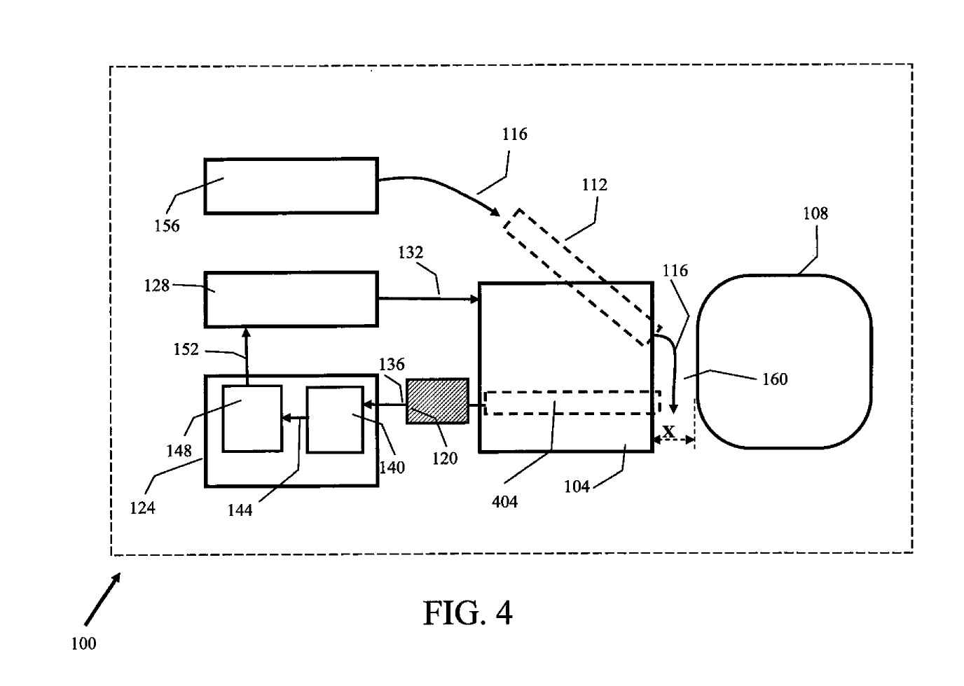

FIG. 4 shows a similar configuration as is described in FIG. 1. In this configuration the pressure sensor 120 is detached from first protected object 104. A pressure sensor pipe 404 is extended from pressure sensor 120 to the possible collision area 160. Pipe 404 delivers the acoustic status from area 160 to pressure sensor 120.

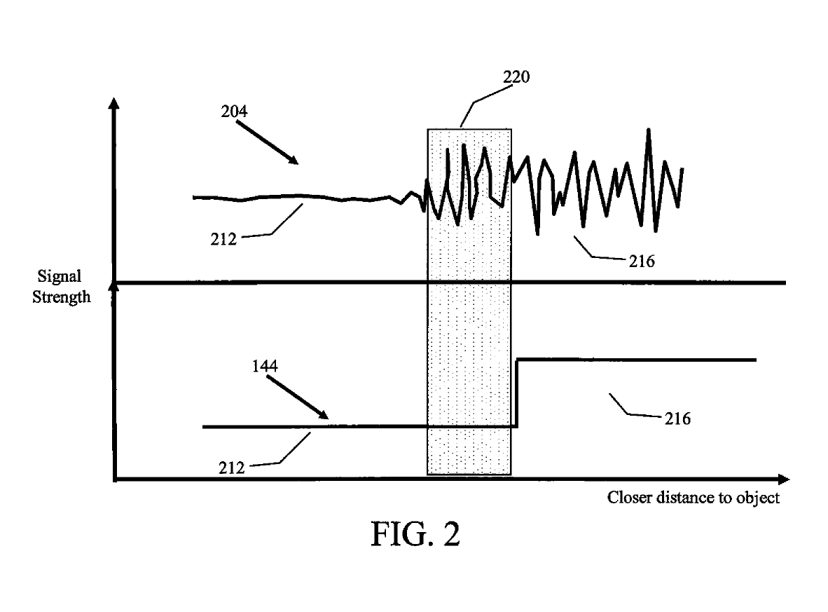

FIG. 2 depicts measured pressure sensor signal 204 as a function to the distance between second protected object 108 and first protected object 104. Pressure sensor signal 204 shows moderate pressure fluctuations when the distance between the objects is far, as is illustrated in region 212. Region 216 shows pressure sensor signal 204 behaviors in the region 216 where the first and second protected objects 104 and 108 are getting closer to each other, and thus pressure sensor signal 204 exhibits significant fluctuations. Such fluctuations may be explained by turbulent manner of exhausted air trapped between first protected object 104 and second protected object 108. A digital collision alert signal 144 is derived from pressure sensor signal 204. Signal analyzer 140 analyzes pressure signal 204 in real time. At the stage where signal analyzer 140 will detect significant fluctuations of pressure sensor signal 204 during at least detection region 220, the alert element 164 will set collision alert signal 144 (as is illustrated in region 216) to alert on a situation that first and second protected objects 104 and 108 are too close to each other.

In an another embodiment of this invention, controller 124 will be set so that first protected object 104 and second protected object 108 are always within a specific range 504 between each other. A collision alert signal 144 will be produced in the case when first protected object 104 is a distance less than minimum the distance 512 from second protected object 108. The collision alert signal 144 will be also produced when the distance between first and second protected objects 104 and 108 is more than the maximum distance 508.

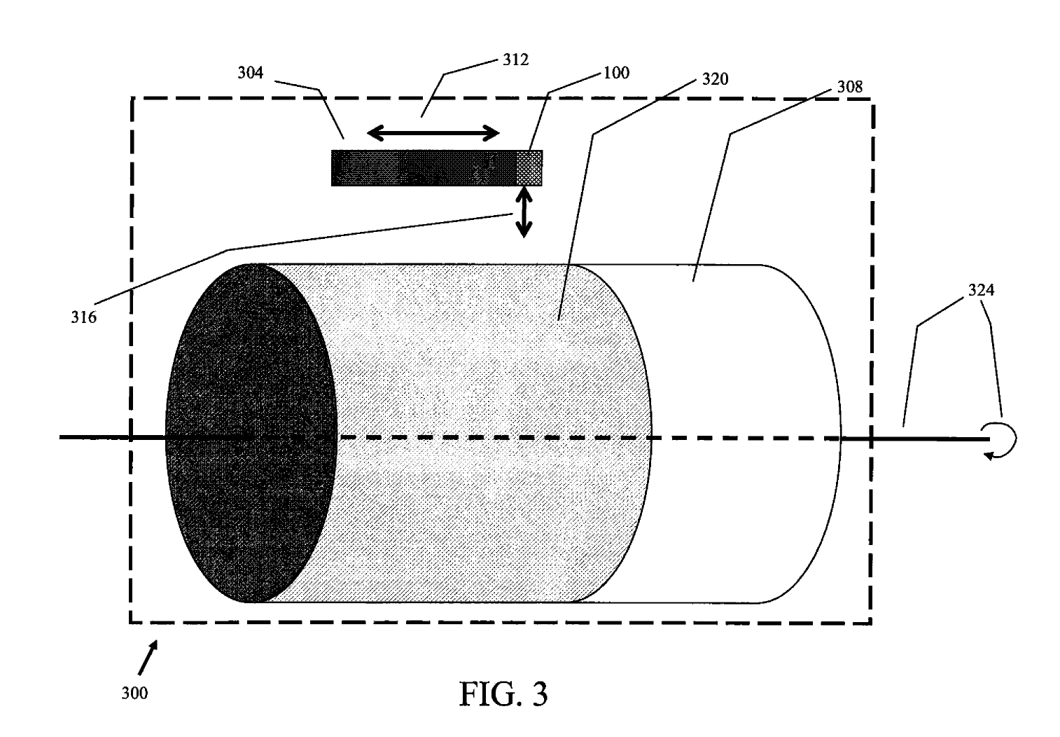

FIG. 3 shows an embodiment of an imaging device 300 comprising an imaging head 304 equipped with collision detector 100 and a rotating drum 308. The imaging head 304 is adapted to move both in parallel 312 to the drum or perpendicular 316 towards rotating drum 308. Rotating drum 308 is adapted to carry plate 320, which is imaged by imaging head 304 as rotating drum 308 rotates around rotation axis 324. Collision detector 100 senses a distance between imaging head 304 and rotating drum 308 alert on hazardous states when imaging head 304 might collide with rotating drum 308 when moving in the perpendicular direction 316.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

The invention has been described in detail with particular reference to certain preferred embodiments thereof but it will be understood that variations and modifications can be effected within the scope of the invention.

### PARTS LIST

100 collision detector
104 first protected object
108 second protected object
112 air flow channel (pipe)
116 air flow
120 pressure sensor (microphone)
124 controller (configurable controller)
128 motor of first object
132 object to motor transmission
136 pressure signal
140 signal analyzer with an alert element
144 collision alert signal
148 motor control logic
152 motor control signal
156 air flow source
160 possible collision area
164 alert element
204 pressure sensor signal
212 region where objects are far from each other
216 region where objects are near to each other
220 detection region
300 imaging device
304 imaging head
308 rotating drum
312 parallel movement
316 perpendicular movement
320 plate
324 drum fast scan direction
404 pressure sensor pipe
504 specified range within proximity of objects 104 and 108 are allowed
508 maximum distance allowed between objects 104 and 108
512 minimal distance allowed between objects 104 and 108

1. A collision detection for detection between a first object and second object wherein said first object is adapted to move in a first direction toward said second object apparatus comprising:
a collision detection element comprised of:
an air flow source element configured to apply an air stream in a second direction;
a pressure sensitive element configured to sense an air pressure between said first object and said second object; and
a pressure data analysis module configured to analyze said air pressure.

2. The collision detection apparatus according to claim 1 wherein an alert element is configured to alert on an abnormal distance range between said first object and said second object.

3. The collision detection apparatus according to claim 1 wherein said pressure data analysis module is attached to said pressure sensitive element.

4. The collision detection apparatus according to claim 1 wherein said pressure sensitive element is a microphone.

5. The collision detection apparatus according to claim 1 wherein said air flow is delivered through a pipe onto said second object.

6. The collision detection apparatus according to claim 1 wherein said air flow is delivered through a pipe onto said first object.

7. The collision detection apparatus according to claim 1 wherein said air flow is delivered through an opening in said pressure sensitive element onto said second object.

8. The collision detection apparatus according to claim 1 wherein said pressure sensitive element is detached from said first object and is configured to sense said air pressure through a pipe extended from said pressure sensitive element to said first object.

9. The collision detection apparatus according to claim 1 wherein said first object is an imaging head and said second object is an imaging cylinder configured to carry an imaging substrate.

10. The collision detection apparatus according to claim 1 wherein said abnormal distance range is less than a minimal allowed distance between said first object and said second object.

11. The collision detection apparatus according to claim 1 wherein said abnormal distance range is more than a maximal allowed distance between said first object and said second object.

12. A method of detecting a distance between a first object and second object wherein said first object is adapted to move relative to said second object comprising the steps:
applying air flow between said first object and said second object;
measuring air pressure between said first object and said second object; and
analyzing said measured air pressure to detect an abnormal distance between said first and second object.

13. The method of collision detection according to claim 12 wherein an alert is activated when an abnormal distance range between said first object and said second object is detected.

14. The method of collision detection according to claim 12 wherein said measuring generated air pressure is performed by a microphone.

15. The method of collision detection according to claim 12 comprising:
moving said first object away from said second object when an abnormal distance is detected.
